(19) United States
(12) Patent Application Publication
(10) Pub. No.: US 2014/0279772 A1
(43) Pub. Date: Sep. 18, 2014

(54) NEURONAL NETWORKS FOR CONTROLLING DOWNHOLE PROCESSES

(71) Applicants: Erik Pennewitz, Braunschweig (DE); Thomas Kruspe, Wietzendorf (DE); Sebastian Jung, Isernhagen (DE)

(72) Inventors: Erik Pennewitz, Braunschweig (DE); Thomas Kruspe, Wietzendorf (DE); Sebastian Jung, Isernhagen (DE)

(73) Assignee: Baker Hughes Incorporated, Houston, TX (US)

(21) Appl. No.: 13/799,983

(22) Filed: Mar. 13, 2013

(51) Int. Cl. G06N 3/02

(52) U.S. Cl. CPC G06N 3/02
USPC 706/16; 706/15

(57) ABSTRACT

An apparatus for processing signals downhole includes a carrier configured to be conveyed through a borehole penetrating an earth formation and a container disposed at the carrier and configured to carry biological material. A cultured biological neural network is disposed at the container, the neural network being capable of processing a network input signal and providing a processed network output signal. One or more electrodes are in electrical communication with the neural network, the one or more electrodes being configured to communicate the network input signal into the neural network and to communicate the network output signal out of the neural network.

### BACKGROUND

Earth formations may be used for various purposes such as hydrocarbon or geothermal production or carbon dioxide sequestration. Boreholes drilled into the earth provide access to the formations. In order to drill a borehole or survey a formation, one or more downhole tools may be conveyed through a borehole penetrating the formation while the borehole is being drilled or through a previously drilled borehole. A downhole tool may contain one or more actuators that need to be controlled by a controller based on inputs received from one or more sensors. Unfortunately, controllers disposed downhole face some challenges. The space available in a downhole tool for the controller and, thus, the complexity of controlling may be limited by the size of the borehole. In addition, the downhole conditions may be extreme both environmentally and from noise and, consequentially, pose reliability concerns. Hence, it would be well received in the drilling and geophysical exploration industries if a downhole controller could be developed that would increase the controlling power and robustness available.

### BRIEF SUMMARY

Disclosed is an apparatus for processing signals downhole. The apparatus includes: a carrier configured to be conveyed through a borehole penetrating an earth formation; a container disposed at the carrier and configured to carry biological material; a cultured biological neural network disposed at the container, the neural network being capable of processing a network input signal and providing a processed network output signal; and one or more electrodes in electrical communication with the neural network, the one or more electrodes being configured to communicate the network input signal into the neural network and to communicate the network output signal out of the neural network.

Also disclosed is a method for processing signals downhole. The method includes: conveying a carrier through a borehole; receiving a network input signal using one or more electrodes coupled to a cultured biological neural network; processing the network input signal using the neural network to provide a processed network output signal; and outputting the network output signal using one or more electrodes coupled to the neural network.

### BRIEF DESCRIPTION OF THE DRAWINGS

The following descriptions should not be considered limiting in any way. With reference to the accompanying drawings, like elements are numbered alike:

FIG. 1 illustrates a cross-sectional view of an exemplary embodiment of a downhole tool disposed in a borehole penetrating the earth;

FIG. 2 depicts aspects of a controller having a biological neuronal network disposed at the downhole tool;

FIG. 3 depicts aspects of an environmental control system for the biological neuronal network; and

FIG. 4 is a flow chart for a method for processing signals downhole.

### DETAILED DESCRIPTION

A detailed description of one or more embodiments of the disclosed apparatus and method presented herein by way of exemplification and not limitation with reference to the figures.

Disclosed are apparatus and method for processing data downhole. The apparatus includes a cultured biological neural (or neuronal) network that can process one or more inputs and provide one or more outputs based on the processing of the one or more inputs. Electrical stimuli are applied to the neural network via one or more electrodes in order to train the network to respond in a desired manner. The neurons in the network form neural connections from the training that result in processing inputs in the desired manner, which may be viewed as a processing algorithm. Electrical inputs, such as from a sensor, are input into the neural network via the one or more electrodes and the network processes the inputs according to the training received by the network. One or more outputs resulting from the processing are provided via the one or more electrodes or other electrodes and may be used to control a device, such as an actuator, may be recorded for future use, or may be transmitted for use by another device.

FIG. 1 illustrates a cross-sectional view of an exemplary embodiment of a downhole tool 10 disposed in a borehole 2 penetrating the earth 3, which may include an earth formation 4. The formation 4 represents any subsurface material of interest that may be sensed by the tool 10. The downhole tool 10 is conveyed through the borehole 2 by a carrier 5, which can be a drill tubular such as a drill string 6. A drill bit 7 is disposed at the distal end of the drill string 6. A drill rig 8 is configured to conduct drilling operations such as rotating the drill string 6 and thus the drill bit 7 in order to drill the borehole 2. In addition, the drill rig 8 is configured to pump drilling fluid through the drill string 6 in order to lubricate the drill bit 7 and flush cuttings from the borehole 2. A downhole drill motor 9 is disposed at the drill string 6 and is configured to rotate the drill bit 7 using drilling fluid flow when the drill string is not rotating such as when the drill string 6 is being directionally steered. Downhole electronics 11 are configured to operate the downhole tool 10, process data obtained downhole, and/or act as an interface with telemetry to communicate data or commands between downhole components and a computer processing system 12 disposed at the surface of the earth 3. Non-limiting embodiments of the telemetry include pulsed-mud and wired drill pipe. In an alternative embodiment, the carrier 5 may be an armored wireline, which can also provide communications with the processing system 12. In wireline logging, the downhole tool 10 is conveyed through a previously drilled borehole.

The downhole tool 10 is configured to sense a parameter of interest using a sensor 13. A controller 14 is configured to receive a sensor signal 15 that conveys parameter measurements from the sensor 13. Non-limiting embodiments of the sensor 13 are a pressure sensor, temperature sensor, orientation sensor, direction sensor, pH sensor, photodetector, chemical sensor, radiation detector (alpha, beta, gamma, or, neutron), spectrometer, acoustic sensor, seismic sensor, magnetic field sensor, electric field sensor, and antenna for receiving electromagnetic signals. The controller 14 is configured to implement an algorithm or procedure of interest that provides an output signal 16 based on the received parameter measurements. The output signal 16 is transmitted to an actuator 17 that is configured to perform a function based on the received output signal 16. The function may be related to a downhole activity such as steering the drill string 6 or performing other measurements with other sensors or analysis devices. Other functions that may be performed include recording an output signal, transmitting an output signal such as to another device or uphole to the processing system 12 using telemetry.

The algorithm or procedure implemented by the controller 14 is performed by a cultured biological neural network 18. In one or more non-limiting embodiments, the cultured biological neural network 18 includes rat cortical neurons, neurons of a lamprey, or other cultured biological neurons. The neural network 18 is a series of interconnected neurons, which when activated define a recognizable pathway. If the sum of input signals into one neuron exceeds a certain threshold, then that neuron sends an action potential to a neighboring interconnected neuron. An action potential (AP) of a neuron is a short-lasting event in which the electrical potential of the neuron rapidly rises and falls generally following a consistent trajectory. A temporal sequence of action potentials may be referred to as a spike train. Electrical signals are used to communicate with the neuron network 18. Non-limiting embodiments of the electrical signals include a voltage level and/or a frequency (such as a pulse-train frequency) that corresponds to a parameter value. In response to receiving an electrical signal, neurons in the neural network 18 will fire sending APs through the network. By sensing the APs, an output signal is provided by the neural network 18.

In order for the neural network to implement a selected algorithm or procedure, the neural network may be trained or taught using selected stimulation signals that result in the neural network providing the desired response. In one or more embodiments, the neural network may be mapped by applying various stimulus signals or combinations of stimulus signals to a multi-electrode array (MEA) that is coupled to the neural network and monitoring responses in the MEA to learn how the network operates and what neural connections result from the stimulation signals. Once the neural network is mapped, stimulus signals are applied to program or drive the network towards a desired response. Once, the neural network is programmed and operating as desired, further training stimulus signal are no longer necessary. Alternatively, literature describes other methods and procedures for training a biological neural network to achieve a desired result.

In one or more embodiments, a first one or more electrodes are used to input a signal into the neural network and a second one or more electrodes are used to receive a processed output signal. Electrodes may be common to the first one or more electrodes and the second one or more electrodes. A desired network input signal is input into the neural network and electrodes are monitored to detect and identify which electrodes output a corresponding desired output signal that corresponds to the selected algorithm. The above steps may be repeated using another (i.e., different) input signal. In this manner, several different input signals may be used to obtain desired responses at locations that correspond to the selected algorithm. It can be appreciated that using a greater number of electrodes increases the likelihood of achieving the desired response.

Reference may now be had to FIG. 2 depicting aspects of the controller 14. In the embodiment of FIG. 2, the cultured biological neural network 18 is disposed at (i.e., in or on) a container 20 that is configured to carry the neural network 18. In one or more embodiments, the container 20 is made of glass or a material that is non-detrimental to the neural network 18. In the embodiment of FIG. 2, a plurality of electrodes 21 is in electrical communication with the neural network 18 and coupled to the neural network at various locations. The electrodes 21 may be used for inputting network input signals 22 into the neural network, receiving network output signals 27 due to the processing of the input network signals 22, or for both functions. In one or more embodiments, the electrodes or the MEA may be embedded in the neural network as the neuronal tissue of the neural network is cultured or grown in order to maintain good electrical contact. In one or more embodiments, the electrodes or MEA may be embedded in a culture dish or container and exposed to the neuronal tissue so that as the neuronal tissue is cultured or grown, the neuronal tissue grows about the electrodes or MEA to maintain good electrical contact. It can be appreciated that the MEA may include a sufficient amount of electrodes and locations in order to provide electrical contact with the neural network in selected, most or all regions of the neural network. It can be appreciated that the electrodes 21 are made from a material, such as gold or silver, which is electrically conductive and inert to the neural network 18. A desired input signal may be input into the neural network using one electrode or multiple electrodes. When multiple electrodes are used, the signal input to each electrode may be the same or different such that the combination of signals provides the desired input signal to the neural network.

An input interface 24 is coupled to one or more electrodes and is configured to convert received signals 25 (such as the sensor signal 15) into the network input signals 22 that are suitable for stimulating the neural network. Because the sensor signal 15 may supply an output signal as a voltage level that is not compatible with stimulating neurons, the input interface 24 converts the sensor signal 15 to a signal that is compatible to stimulating the neurons in the neuron network. Alternatively, if the sensor signal 15 is compatible with stimulating neurons directly in the neural network, then the input interface 24 may not be required.

An output interface 26 is coupled to one or more electrodes in the plurality and is configured to convert network output signals 27 into compatible output signals 28 (e.g., the output signals 16) that are compatible with performing desired functions downhole such as being recorded or transmitted or activating the actuator 17. In one or more embodiments, the output interface 26 includes an amplifier configured to amplify the network output signals 27 to a level that is compatible or suitable for being transmitted to other devices. Alternatively, if the network output signals 27 are compatible with a receiving device such as the actuator 17, then the network output signals 27 may be used directly as the output signal 16 or 28 and the output interface 26 may not be required.

Reference may now be had to FIG. 3 depicting aspects of an environmental control system 30. The environmental control system includes an insulated barrier 31 configured to contain an environment downhole that is conducive to the health of the biological neural network 18. The environment may include a selected pressure, temperature, atmosphere, and nutrition. Temperature may be maintained within a selected temperature range using a thermostat 32 coupled to a cooling device 33 and/or a heating device 34. In one or more embodiments, the temperature is maintained at about 37° C. or 100° F. The oxygen in the contained atmosphere may be maintained within a selected range using an atmosphere recirculator 35 (e.g., fan or pump), a carbon dioxide scrubber 36, and an oxygen supply 37. To maintain sufficient nutrition to the biological neural network 18, the environmental control system 30 includes a nutrition dispenser 38. In one or more embodiments, the nutrition dispensed includes one or more sugars in a solution. The environmental control system may be controlled by the downhole electronics 11, the computer processing system 12, and/or the neural network 18, itself. It can be appreciated that an electrical penetration 39 or a mechanical penetration 29 may be used to penetrate the insulated barrier 31 and maintain its integrity in order for exterior components to communicate electrically or mechanically with the interior environment.

Reference may now be had to FIG. 4 presenting a flow chart for a method 40 for processing signals downhole. Block 41 calls for conveying a carrier through a borehole penetrating an earth formation. Block 42 calls for receiving a network input signal using one or more electrodes coupled to a cultured biological neural network disposed at the carrier. Block 43 calls for processing the network input signal using the neural network to provide a processed network output signal. Block 44 calls for outputting the network output signal using one or more electrodes coupled to the neural network.

It can be appreciated that the cultured biological neural network provides several advantages in a downhole environment. One advantage is that the biological neural network is robust both in computational power and against electrical noise, dysfunction or disruption. In addition, in that the biological neural network is pliable and has some elasticity, the neural network is also robust against vibration. Theoretically, the velocity of a “conventional” (i.e., electronic) computer (CC) should be superior to a cultured neuronal network by generally about 6 orders of magnitude because the response time/circuit time of the elements of a CC (e.g., transistors) is faster. However, the brain/connected neurons are computing massively in parallel (massive parallel computing). Most of the neurons are computing in parallel and are operating while in a CC normally most of the elements are passive during operation. While just a few transistors in a CC may be computing in an instant, in a brain or cultured neural network all or most neurons may be active at any instant to provide greater computational power.

Because the biological neural network has an ability to grow, the neural network has a self-healing or repair property, which can be useful when the network is disposed in a borehole as it can take a significant amount of time to remove a conventional controller/processor from the borehole. The “knowledge” in a biological neural network is distributed throughout the network and, thus, has fault tolerance or an ability to continue to operate with the loss or blackout of some neurons or a region of the neural network. Further, other new neurons may be replacing the lost neurons due to self-healing. In contrast, in a CC the blackout of some elements or algorithms can cause inoperability of the whole CC. Another advantage of the biological neural network is its ability to keep learning or being retrained downhole as conditions and requirements change.

In support of the teachings herein, various analysis components may be used, including a digital and/or an analog system. For example, the downhole electronics 11, the computer processing system 12, the sensor 13, the actuator 17, the input interface 24, or the output interface 26 may include digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second” and the like do not denote a particular order, but are used to distinguish different elements.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for processing signals downhole, the apparatus comprising:
a carrier configured to be conveyed through a borehole penetrating an earth formation;
a container disposed at the carrier and configured to carry biological material;
a cultured biological neural network disposed at the container, the neural network being capable of processing a network input signal and providing a processed network output signal; and
one or more electrodes in electrical communication with the neural network, the one or more electrodes being configured to communicate the network input signal into the neural network and to communicate the network output signal out of the neural network.

2. The apparatus according to claim 1, further comprising an environmental control system configured to control an environment experienced by the neural network at a condition that provides for survival of the neural network.

3. The apparatus according to claim 2, wherein the environmental control system comprises an insulated barrier surrounding at least part of the container;

4. The apparatus according to claim 3, wherein the environmental control system comprises a thermostat in temperature communication with the environment, the thermostat being coupled to at least one of a heating device and a cooling device.

5. The apparatus according to claim 2, further comprising a nutrition dispenser configured to dispense a nutritional substance to the neural network.

6. The apparatus according to claim 2, wherein the environmental control system comprises at least one of a carbon dioxide scrubber, an oxygen supply, and an atmosphere circulator.

7. The apparatus according to claim 1, further comprising an input interface coupled to the one or more electrodes and configured to convert a signal into the electrical input signal.

8. The apparatus according to claim 1, wherein the network input signals comprise at least one of voltage level and a frequency of electrical pulses.

9. The apparatus according to claim 8, wherein the network input signals are applied to a plurality of the electrodes.

10. The apparatus according to claim 8, wherein the network input signals comprise a combination of signals applied to the plurality of electrodes, each signal in the combination being different from other signals in the combination.

11. The apparatus according to claim 1, further comprising a sensor coupled to the neural network and configured to measure a parameter.

12. The apparatus according to claim 1, further comprising an output interface coupled to the one or more electrodes and configured to convert the network output signal to a format that is compatible with an output device.

13. The apparatus according to claim 12, wherein the output device is at least one of a recorder, a telemetry device, a transmitter, and an actuator configured to provide a mechanical motion.

14. A method for processing signals downhole, the method comprising:
conveying a carrier through a borehole;
receiving a network input signal using one or more electrodes coupled to a cultured biological neural network;
processing the network input signal using the neural network to provide a processed network output signal; and
outputting the network output signal using one or more electrodes coupled to the neural network.

15. The method according to claim 14, further comprising converting a signal into the network input signal using an input interface.

16. The method according to claim 14, further comprising converting the network output signal to a format that is compatible with an output device.

17. The method according to claim 14, further comprising training the neural network to implement a desired algorithm.

18. The method according to claim 17, wherein training comprises:
mapping the neural network by applying a plurality of stimulus signals to the neural network and monitoring a response from the neural network to determine neural connections resulting from the applying; and
applying selected stimulus signals to the neural network to achieve desired neural connections that implement the desired algorithm.

19. The method according to claim 18, wherein training comprises:
applying a first stimulus signal to the neural network and monitoring locations of one or more first responses from the neural network to determine a first location having a desired response;
applying a second stimulus signal to the neural network and monitoring locations of one or more second responses from the neural network to determine a second location having a desired response; and
using the first location and/or the second location to implement the desired algorithm.
